(19) United States
(12) Patent Application Publication
(10) Pub. No.: US 2012/0310622 A1
(43) Pub. Date: Dec. 6, 2012

(54) Inter-language Communication Devices and Methods

(75) Inventors: Aleksandar Zivkovic, North York (CA); Mark Charles Hale, Whitby (CA); Justin Earl Marek, Richmond Hill (CA)

(73) Assignee: ORTSBO, INC., Toronto (CA)

(21) Appl. No.: 13/456,772

(22) Filed: Apr. 26, 2012

Related U.S. Application Data
(60) Provisional application No. 61/492,545, filed on Jun. 2, 2011.

(51) Int. Cl. G06F 17/28

(52) U.S. Cl. 704/3; 704/E15.043

(57) ABSTRACT

A single device allows two or more users to converse in different languages. The translation device receives inputs from the users which are translated and displayed to the other user in the other user's selected language. In one embodiment, there are two display areas for right side up display of the conversation to each user. In a second embodiment, one display is changed from one language to another as it is passed from one user to the other.

The present application claims priority from U.S. provisional application serial no. 61/ 492,545, filed Jun. 2, 2011, the full disclosure of which is hereby incorporated by reference herein.

### TECHNICAL FIELD

The present invention relates to language translation devices and methods, and more particularly to a single device that can be conveniently shared by two users communicating in different languages.

### BACKGROUND ART

Ever since the advent of multiple languages, humanity has strived for a universal language translation tool. The advances in computer based language translation have enabled the building blocks for such a dream. The creation of language translation tools has enabled translation of text written in one language to another language. However, the process of translating desired text is often cumbersome, with the requirement of marking up the text that needs to be translated, pasting it into a tool and then activating the translation software to perform the translation to produce the output in the desired language. Systems have been implemented that make this process more natural, by integrating the translation process into the natural exchange of text within a conversation, for example, as in an instant messaging sessions. However, this mode of operation assumes that each of the parties has access to either an application or web site, on their own device, which can perform the translation. In reality, one can envision situations where only one of the parties has a device that is capable of translation.

### SUMMARY OF THE EMBODIMENTS

Embodiments of the invention enable two or more users to communicate in their languages of choice by using one device. The users determine what language they wish to use. Text is entered into the device. In one embodiment, the device is showing two keyboards and two output screens, where the entered text is translated into each users selected language of choice. In another embodiment, the user enters text and then performs a gesture, such as tilting the device, flipping the device or pressing a button, so that the text is displayed in the other user's language of choice, whereupon, the other user(s) can perform the same task. There can be any number of users that share the device—as each user receives the device, the text is translated to his or her language of choice. Each user enters the text that he/she wishes to communicate and passes the device to the next user.

A method of the device receives a first input and displays it in a first language on the display of the device. The input is translated to a second language and displayed on the device. The device receives a second input in the second language and displays it in the second language on the display of the device. The second input is translated into the first language and displayed on the device in the first language. In the one embodiment, the display has two areas each displaying the inputs in one of the two languages. In the other embodiment, the display is shared and switches from displaying inputs in one language to displaying the inputs in the second language upon generation of a switch command.

One embodiment of a real-time translation device includes two display areas, each for right side up viewing by each of two users positioned facing one another. The device includes an input for receiving user inputs. For example, an input can be a microphone or a keyboard for each user. The keyboards can be physical or virtual soft keyboards on a touch screen display. A microphone input would be accompanied by a speech-to-text converter. The device further includes a translator configured to translate user inputs from one language of a plurality of languages to another language of the plurality of languages. The translator may process the translations in the device or it may include a transmitter and a receiver which communicate with a remote server for processing translations. The translation device is configurable by the two users so that it displays user inputs in the first display area as text in a first of the plurality of languages and displays user inputs in the second display area as text in a second of the plurality of languages.

A real-time translation device of another embodiment includes an input for receiving user inputs, a display area for viewing text derived from the user inputs and a translator configured to translate user inputs from one language of a plurality of languages to another language of the plurality of languages. The device further includes a processor configured to respond to a switch command by causing text displayed in a first language in the display area to be replaced by the same text translated into a second language. The switch command may be generated by physical movement of the translation device. A gyrometer in the device enables flipping or tilting of the device to trigger the display to change from one language to the next. Alternatively, the switch command may be generated by a physical button, a soft on-screen button or a gesture detection module. The inputs and translator on the device may be any of those described with regard to the first embodiment.

According to a method of using the translation device of the second embodiment, a first text in a first language is displayed on the device. The text is electronically translated into a second language. Physical movement of the device through different orientations after displaying the first text in a first language, generates a switch command to initiate display of the translated text in a second language. When a second text in the second language is received in the device, it is displayed on the device in the second language. The second text is electronically translated into the first language. Again physical movement of the device generates the switch command to initiate display of the translated text.

The methods performed by the translation device may be encoded on a computer readable medium. A further embodiment is a computer readable medium having stored thereon instructions for displaying a first user input in a first language, accepting selection of a second language, translating the first user input into the second language, displaying the translated first user input, receiving second user input in the second language, displaying the second user input in the second language, translating the second user input into the first language, and displaying the translated second user input. A further instruction which may be included is a command to either display the user inputs entirely in the first language or to display the user inputs entirely in the second language. Thus, a conversation history may be conveniently displayed for each user in the user's selected language.

Other objects and advantages of the invention will become apparent during the following description of the presently preferred embodiments of the invention taken in conjunction with the drawings.

### BRIEF DESCRIPTION OF THE DRAWINGS

The foregoing features of embodiments will be more readily understood by reference to the following detailed description, taken with reference to the accompanying drawings, in which:

FIG. 1 is a flow chart of a method of inter-language communication in accordance with embodiments of the present invention.

FIG. 2 is a plan view of a display on a real-time translation device of an embodiment of the invention.

FIG. 3 is a flow chart of a method of inter-language communication in accordance with an embodiment of the invention.

FIG. 4 is a plan view of a display on a real-time translation device practicing the method of FIG. 3.

FIG. 5 is a plan view of the display on the real-time translation device of FIG. 4 after generation of a switch command.

FIG. 6 is a schematic block diagram of an embodiment of a real-time translation device.

### DETAILED DESCRIPTION OF SPECIFIC EMBODIMENTS

Definitions. As used in this description and the accompanying claims, the following terms shall have the meanings indicated, unless the context otherwise requires:

The term “real-time” means that the users are provided with the translation results while they are engaged in a conversation through the translation device, each such result is produced in less than a couple minutes.

The term “upright viewing of text” means that text is presented to a user so that it can be read, in other words, the text is not upside down for the user.

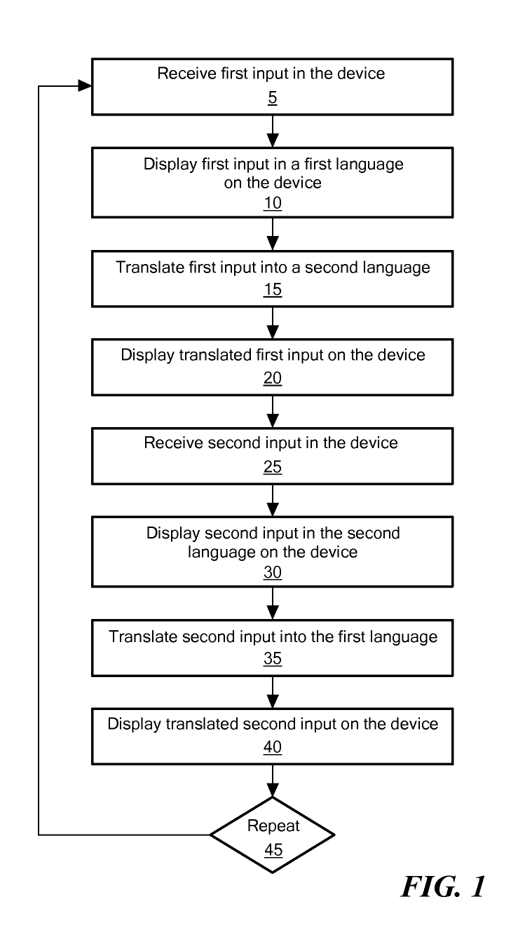

Referring now to FIG. 1, a method for conducting a conversation in different languages is shown. A translation device receives 5 a first input. Such input may be provided by a first user through a keyboard in connection with the device. The keyboard may be a physical keyboard or a soft keyboard displayed on a touch screen display. Alternatively, the input may be provided by voice into a microphone on the translation device. Speech-to-text software in the device or readily accessible to the device converts the voice signals to text in the spoken language.

The device would need to know the languages to be used. In one embodiment, the translation device may be programmed with the ability to determine the language of the text that has been input. In other embodiments, the languages to be used are selected on the device. For example, a menu of possible languages may be displayed for selection by a user. Alternatively, the identification of a language may be entered by typing the identity of the language on the keyboard.

The first input from the first user is displayed 10 on the device in the language of the first user. The user thus sees that the input has been correctly entered. The device translates 15 the first input into the language selected on behalf of the other user of the device participating in the conversation. If additional users are participating in additional languages, such additional translations may also be made. The device may contain translation software for performing the translations. Alternatively, the translator module of the translation device may engage transmitter and receiver electronics for communication with a remote translation server. The translation would thus be obtained by the translator module of the device from the translation server.

The translated first input may now be displayed 20 on the device. Thus, the second user can see the first user's input in a selected language in real time. The conversation may continue efficiently and naturally in with each user seeing the conversation history in his or her language of choice. The second user may respond with input in the second language. The translation device receives 25 the input from, for example, a keyboard or microphone. The second input is displayed 30 in the second language for viewing by the second user. The second input is electronically translated 35 into the first language. As before, the translation may be performed in software in the device or in a translation server. To complete one iteration of the conversation, the translated second input is displayed 40 in the first language on the translation device for viewing by the first user. The users may continue to use the translation device to communicate back and forth, each user viewing the conversation in his or her own selected language. The translation device repeats 45 the process as described above. The selection of languages only needs to be completed in the first iteration of the conversation. The full history or a portion of the most recent history may be made available by the device for viewing.

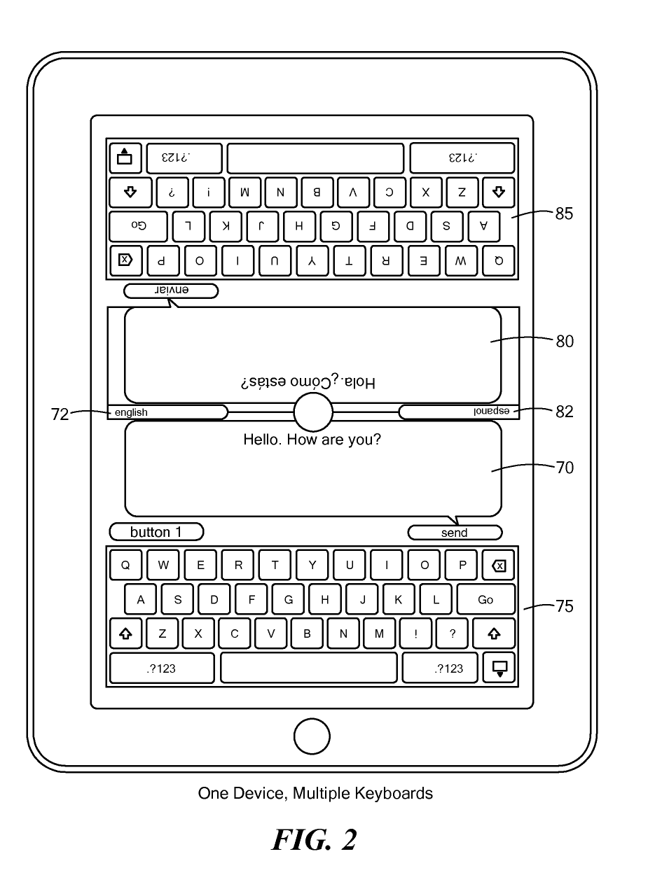

In one embodiment, the translation device provides two display areas as shown in FIG. 2. This configuration of the translation device allows two people to have cross language text conversations while positioned facing each other with the device in between them. The display on the translation device presents a first display area 70 for right side up viewing of text by a first of two users. With a second user positioned across from the first user, a second display area 80 is oriented for right side up viewing of text by the second user facing the first user. The respective display areas allow each user to see conversation content including one's own inputs and the translated inputs of the other user.

The translation device includes an input for receiving inputs from each of the two users. The input may be a microphone which both of the users may use for speech inputs to be converted to text. In such case, the translation device is provided with a speech-to-text converter. Alternatively, as shown, each user may be presented with a keyboard in the area closest to him for use as the input. On a tablet device such as the one shown in FIG. 2, the keyboards 75, 85 are soft keyboards activated by touching the touch screen display. A translation device may instead be provided with physical keyboards embedded in the device or electronically connected to the device. The electronic connection may be wired or wireless.

The translation device of FIG. 2 can allow users to select corresponding languages on their part of the screen. The language selection might be represented through a drop-down menu or as part of the keyboard interface. In the example of FIG. 2, one of the users has selected English 72 and the other has selected Spanish 82.

One of the users types on his keyboard text to be communicated. The text is entered in the user's own selected language and is displayed in that language on the user's side of the device. In the example of FIG. 2, the English user has entered the phrase “Hello. How are you?”

The translation device includes a translator configured to translate user inputs from one language to another language. The translator may have the ability to translate among any of a plurality of languages. For example, a program such as Google Translate may be used. The translation program may be included in the translation device. Alternatively, the translator of the device may use a transmitter and receiver to communicate with a remote translation server where translation programs are run. The text entered by the first user, the English user in the example, is translated into the other person's language of choice (e.g., Spanish). The translated text is displayed in the second user's display area 80. This can be seen in FIG. 2 as the translated text “Hola. Como estas?”

If the users wish to exchange further information, for example, if the Spanish speaking user now wishes to respond to the text shown in FIG. 2, the same process is repeated, but in the opposite direction. The Spanish speaking user enters text on his keyboard in Spanish. Once submitted, the text is translated and displayed in English on the English speaking user's display area 70. The cycle may be repeated through an entire conversation. The conversation history or a recent portion of that history may remain displayed in each user's display area in the respective user's language.

Note that the process flow is not to be interpreted as requiring linear entry of text of one user followed by entry of text of the other user. Users can enter text at the same time, if so desired but the general translation process is the same- whatever text is entered is shown on the user's display area and translated text is shown on the other user's display area.

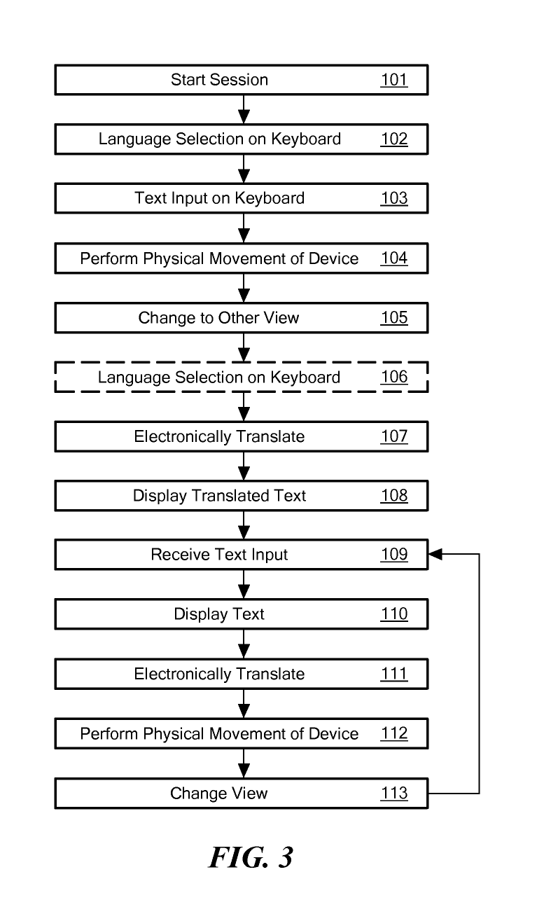

Another embodiment of the invention shall now be described with reference to FIGS. 3-5. Users share the translation device as they sit or stand in proximity to one another. The users initially agree to communicate using the single translation device (how this is practically done is outside the scope of this description but one can imagine that it would be a combination of gestures and rudimentary language exchange). The application is started 101 and an initial screen is displayed.

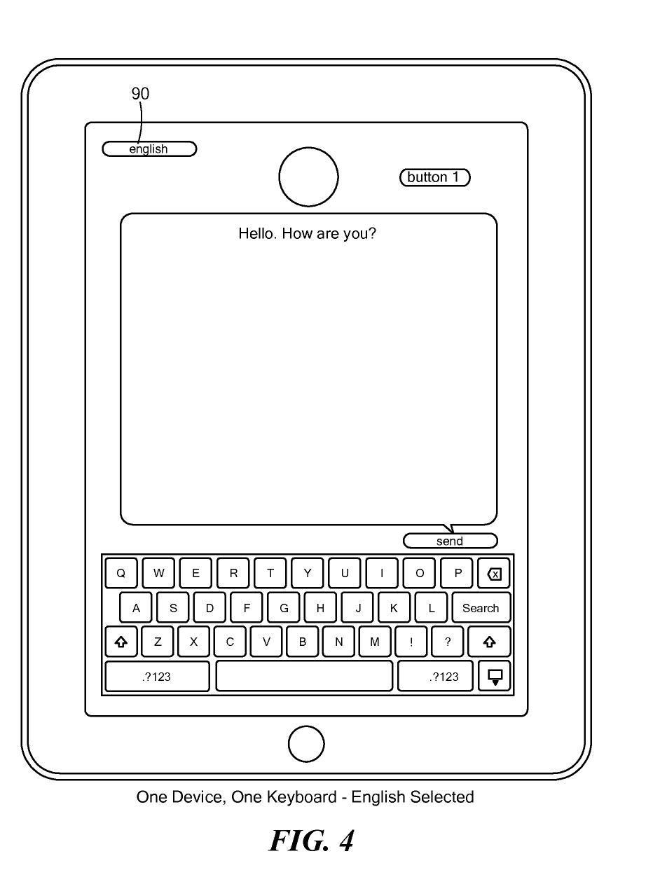

The first user selects 102 language either from drop-down selection . For example, the language selection area 90 may open up and provide a list of available languages. The language names may appear in one or more languages and may be accompanied by a more universally recognized icon such as a country flag. On a touch screen, a user need only touch the selected language on the menu. In FIG. 4, English has been selected. Other methods of entering a selected language such as typing the name of the language on a keyboard may also be accommodated. The nature of the language selection is not important to the overall function of the embodiments of the invention. For example, user might say something in his language of choice, the received voice output can be analyzed by the translation device, and the language is detected and automatically selected. Alternatively, the “owner” of the translation device, might have selected his language previously and saved his choice as part of the settings for the application.

The first user enters text input 103 that he wishes to communicate on the keyboard. Any of a number of inputs may be used including at least a soft keyboard, a hardware keyboard or voice signal input through a microphone. The text is displayed in the user's language. (Note that it is not mandatory for the text to be entered in the selected language choice since translation software can detect language and translate to the user choice of language.) In FIG. 4, the user has entered the phrase “Hello. How are you?”

The user physically moves 104 the device through different orientations so that the movement is detected by the device to generate a switch command. If the users are facing each other, the first user may quite naturally tilt the device away from him so that it is now inclined the other way for viewing by the other user. The device includes a gyrometer which may be implemented by one or more gyrometers or accelerometers. These electronic devices detect changes in orientation. So the device can flip its display for right side up viewing by the other user when the device is tilted or flipped over. Certain thresholds would be programmed into the device so that when a physical movement of the device crosses the thresholds, a switch command is generated. For example, the movement of the device from an incline along the long axis from −x (e.g. −20) degrees to +x degrees (e.g. +20) degrees (the angles are based on z-axis going through the middle of the device long axis) can be interpreted as passing the device from one to the other user. Other movements can be used as well such as shaking, passing left or right, or any other action that can be determined through the device accelerometers, gyros or other sensors. Instead of using physical movement, the device may be configured for generating a switch command by direct manual means such as pressing an actual or soft button, sliding an actual or soft slide switch or toggling an actual or soft switch. The soft elements are on screen elements for touch activation on the touch screen display.

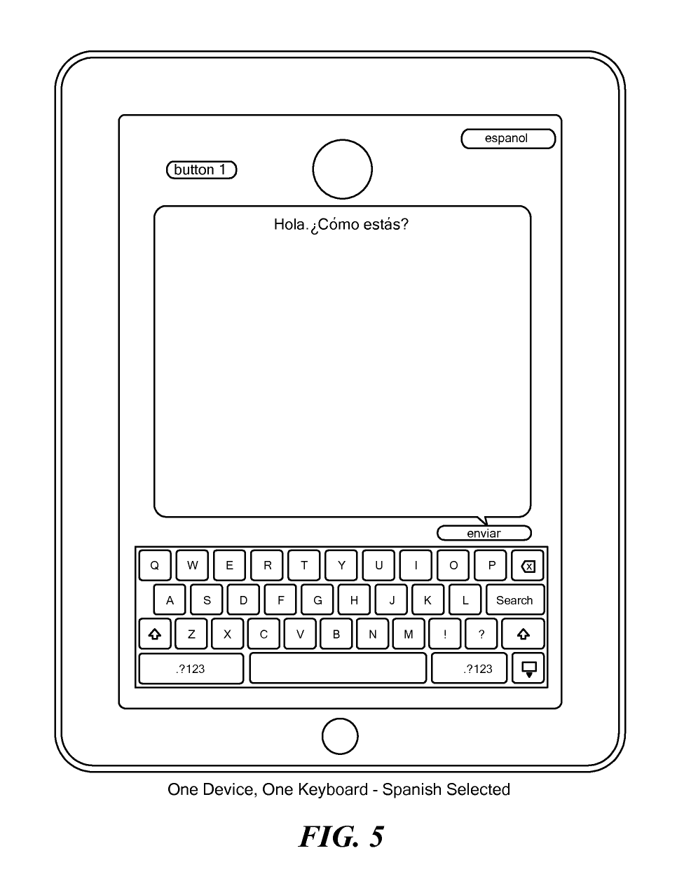

A switch command causes the view on the translation device to change 105. The view is changed from the first user's view (FIG. 4) to the second (or other) user's view (FIG. 5). If this is the first time that the second user is seeing the view, the language may not have been selected and the text may not yet have been translated. Thus, if necessary, the user selects 106 the language of his choice either from the drop down menu, a button or through alternate means such as entry through the keyboard or automatic language detection of speech. Note that this act is only needed the first time through the cycle—on subsequent passes the previous selection is remembered.

Text entered by the first user is electronically translated 107 into the language selected by the second user. The generation of a switch command by physical movement of the device from one user to the next, or otherwise, initiates display of the translated text in the language selected by the second user. The translated text is displayed 108.

Once the languages for the conversation have been selected, the single translation device enables two persons to communicate back and forth easily even though using different languages. Simply flipping the device over from one user to the next changes the displayed conversation history from being displayed in one user's language to the language of the receiving user. The conversation cycle is shown in FIG. 3. The device receives 109 text from a user and displays 110 the text in that user's selected language. The text is electronically translated 111 to the other user's selected language. The user who just entered the text then hands the device over to the other user making a physical movement 112 with the device which generates the switch command. The switch command causes the displayed view of text on the screen to change 113 from one language to the language of the receiving user. This cycle continues for as long as the conversation proceeds.

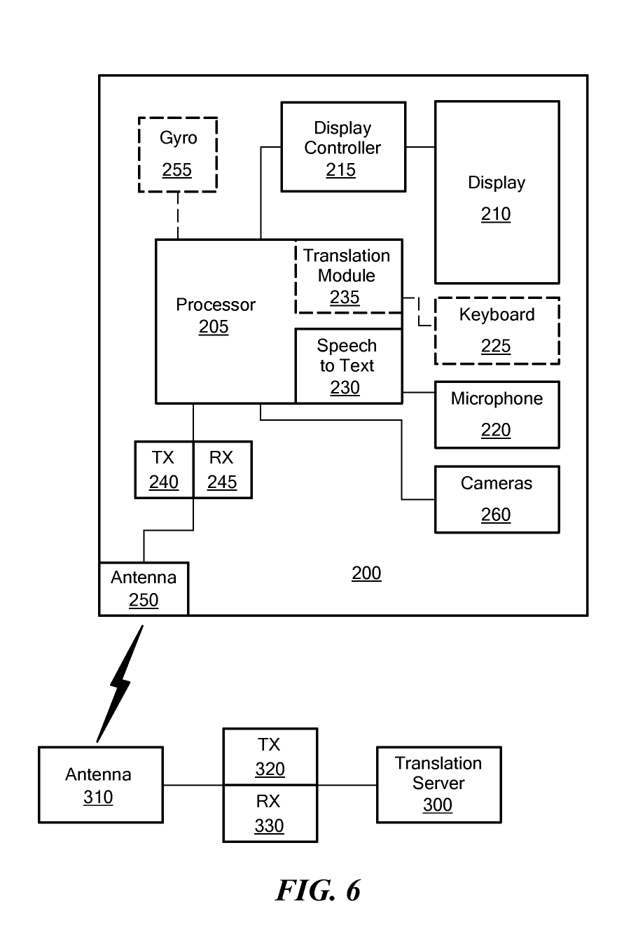

Referring now to FIG. 6, a block diagram of a translation device 200 is shown. The device includes a processor 205 suitably programmed by instructions for performing the methods described above when running the inter-language communication program. Such instructions may include instructions for displaying inputs entered by a user. The processor 205 may be a single processor, a multiprocessor or a combination of a plurality of processors. The translation device includes a display 210, preferably a touch screen display. The processor 205 may operate the display directly or through a display controller 215. The processor 205 is responsive to commands and data input through the touch screen display or through other inputs on the translation device 200, such as a microphone 220 or an actual keyboard 225. An actual keyboard 225 is not required. A soft keyboard may be implemented on the display 210 in accordance with a keyboard routine processed in the processor 205. The processor may advantageously include a speech-to-text computer program 230 which converts speech signals into text. The processor 205 can display the text on display 210.

Language selections made through the display 210 or another input are accepted by the processor. Such selections are used in conjunction with a translator, which may be implemented as a software module 235 in the processor. Conventional translation software may be used to translate text from one language to another selected language. Rather than perform all the translation processing in processor 205, the translator may include instructions for communicating with an external translation server 300. Wireless communication permits the translation server 300 to be located anywhere. The translation device 200 would include transmit 240 and receive 245 circuitry for communicating through an antenna 250. The translation server 300 would also include an antenna 310 and transmit 320 and receive 330 circuitry for wireless communications. The translator could thus send text to the translation server for translation and receive back the translated text. The processor 205 may then display the translated text on the display 210 when instructed to do so.

Instructions may be provided to create two display areas on the display 210. Each display may show the text of a conversation in the language of the respective user as determined by the language selections. The display areas may be arranged so that each of two users positioned facing one another may view his respective area right side up in his selected language.

Alternatively, a single display may be provided in just one of the selected languages as shown in FIGS. 4 and 5. Instructions may be provided to receive a switch command, in response to which the display will be changed from displaying user inputs in one language to displaying user inputs in another selected language. The switch command may be generated in response to signals from a gyrometer 255. The gyrometer may be implemented by one or more gyrometers or a plurality of accelerometers. These devices detect changes in physical orientation of the translation device 200. When a change in orientation exceeds a programmed threshold, the signals from the gyrometer 255 generate the switch command. The gyrometer 255 enables the translation device to re-orient its display to be right side up even when the translation device is flipped upside down. The switch from one language to another can be made to coincide with re-orienting the display. Thus, the translation device 200 can provide a seamless conversation between two users in different languages as each user views the display and flips the device over for right side up viewing of the display in another language by the other user.

Instead of generating a switch command using the gyrometer, other mechanisms may be used. For example, a physical button or slide switch on the translation device may be included on the translation device 200 for issuing the switch command. A soft button or slide or the like may be depicted on the display 210 the activation of which may issue a switch command. Cameras 260 may be included on the translation device and used to detect gestures. A gesture detection module in the processor 205 may be programmed to generate a switch command in response to certain gestures. Alternatively a switch command can be generated by an input through the microphone 220, the keyboard 225 or a soft keyboard.

The instructions used in embodiments of the present invention may be embodied in many different forms, including, but in no way limited to, computer program logic for use with processor 205 (e.g., a microprocessor, microcontroller, digital signal processor, or general purpose computer). In a specific embodiment, instructions are provided in an application program downloadable into a tablet device, such as an iPad, made by Apple Inc. of Cupertino, Calif.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method of inter-language communication using a single device comprising:
receiving, in the device, input from a first user;
displaying the first user input in a first language on a display on the device;
electronically translating the first user input into a second language;
displaying the translated first user input on the display;
receiving, in the device, input from a second user;
displaying the second user input in the second language on the display on the device;
electronically translating the second user input into the first language; and
displaying the translated second user input on the display.

2. The method of claim 1 wherein the display includes a first area and a second area and wherein the first user input in the first language and the translated second user input get displayed in the first area and wherein the second user input in the second language and the translated first user input get displayed in the second area.

3. The method of claim 2 wherein the display comprises a touch screen display displaying a first keyboard for receiving input from the first user and a second keyboard for receiving input from the second user.

4. The method of claim 1 wherein the acts of displaying the translated first user input and displaying the translated second user input are each initiated by a switch command.

5. The method of claim 4 wherein a switch command is generated in response to tilting the device.

6. The method of claim 4 wherein generating a switch command comprises physically moving the device to a different orientation, said movement being detected by the device and generating the switch command upon exceeding a threshold.

7. The method of claim 4 wherein generating a switch command comprises pressing an on screen button.

8. The method of claim 4 wherein generating a switch command comprises pressing a physical button.

9. The method of claim 4 wherein generating a switch command comprises making a gesture detected by the device.

10. The method of claim 1 wherein the input from the first user is a voice input and further comprising converting speech in the voice input to text.

11. A real-time translation device for use by two users comprising:
a first display area for right side up viewing of text by a first of the two users;
a second display area oriented for right side up viewing of text by a second of the two users positioned facing the first user;
at least one input for receiving user inputs;
a translator configured to translate user inputs from one language of a plurality of languages to another language of the plurality of languages, wherein the translation device is configurable by the two users so that it displays user inputs in the first display area as text in a first of the plurality of languages and displays user inputs in the second display area as text in a second of the plurality of languages.

12. The device of claim 11 wherein the at least one input comprises a microphone and further comprising a speech-to-text converter.

13. The device of claim 11 wherein the at least one input comprises a first soft keyboard and a second soft keyboard oriented for use by each of the two users positioned facing each other.

14. The device of claim 11 wherein the translator comprises a transmitter, a receiver and a server, wherein the user input is transmitted to the server for translation and the translated input is received from the server.

15. A real-time translation device for use by two or more users comprising:
an input for receiving user inputs;
a display area for viewing text derived from the user inputs;
a translator configured to translate user inputs from one language of a plurality of languages to another language of the plurality of languages; and
a processor configured to respond to a switch command by causing text displayed in a first language in the display area to be replaced by the same text translated into a second language.

16. The device of claim 15 further comprising a gyrometer and wherein the switch command is generated by tilting the real-time translation device.

17. The device of claim 15 further comprising a gesture detection module which generates a switch command in response to a gesture.

18. The device of claim 15 further comprising a physical button or a soft on-screen button for generating a switch command.

19. The device of claim 15 wherein the input on the device is a physical keyboard, a soft on-screen keyboard or a microphone.

20. The device of claim 19 further comprising a speech-to-text converter.

21. The device of claim 15 wherein the translator comprises a transmitter, a receiver and a server, wherein the user input is transmitted to the server for translation and the translated input is received from the server.

22. A method of inter-language communication using a single device comprising:
displaying a first text in a first language on a display on the device;
electronically translating the first text into a second language;
physically moving the device through different orientations after displaying the first text in a first language, said movement being detected by the device so as to generate a switch command;
initiating display of the translated text in a second language on the display in response to the switch command;
receiving in the device a second text, the second text being in the second language;
displaying the second text in the second language on the display on the device;
electronically translating the second text into the first language;
physically moving the device through different orientations after displaying the second text in the display, said movement being detected by the device so as to generate a switch command; and
displaying the translated second text on the display.

23. A non-transitory computer readable medium having stored thereon sequences of instructions for supporting inter-language communication, the sequences of instructions including instructions for:
displaying a first user input in a first language;
accepting selection of a second language;
translating the first user input into the second language;
displaying the translated first user input;
receiving second user input in the second language;
displaying the second user input in the second language;
translating the second user input into the first language; and
displaying the translated second user input.

24. The computer readable medium of claim 23 wherein the instructions for displaying the first user input and displaying the translated second user input specify a first display area and the instructions for displaying the second user input and the translated first user input specify a second display area distinct from the first display area.

25. The computer readable medium of claim 23 further includes instructions for receiving a command to either display the user inputs entirely in the first language or to display the user inputs entirely in the second language.
